(19) United States
(12) Patent Application Publication
(10) Pub. No.: US 2026/0006455 A1
(43) Pub. Date: Jan. 1, 2026

(54) SYSTEM AND METHOD FOR OPTIMUM SITE SELECTION AND DEPLOYMENT

(71) Applicant: JIO PLATFORMS LIMITED, Ahmedabad, Gujarat (IN)

(72) Inventors: Haresh B AMBALIYA; Preetam Kumar SAHU, Ranchi, Jharkhand (IN); Aayush BHATNAGAR, Navi Mumbai, Maharashtra (IN); Pradeep Kumar BHATNAGAR, Navi Mumbai, Maharashtra (IN); Sundaresh SANKARAN; Vikram SINGH; Himanshu PATEL, Navi Mumbai, Maharashtra (IN); Polsoni Chaitanya REDDY, Tellapur, Hyderabad (IN); Deepak PAL, Indore, Madhya Pradesh (IN)

(73) Assignee: JIO PLATFORMS LIMITED, Ahmedabad, Gujarat (IN)

(21) Appl. No.: 18/992,618

(22) PCT Filed: Feb. 20, 2024
(86) PCT No.: PCT/IN2024/050182

§ 371 Date: Jan. 9, 2025

(30) Foreign Application Priority Data
Feb. 24, 2023 (IN) 202321012787

(51) Int. Cl. H04W 16/18

(52) U.S. Cl. CPC H04W 16/18

(57) ABSTRACT

The present invention discloses a method for determining and deploying a nominal site location for cellular planning in a wireless network. The method comprising receiving, from one or more data sources, geographic data related to a geographic region of interest. The method comprising obtaining a data for the geographic region of interest. The method comprising receiving at least one input for the cellular planning. The method comprising identifying a first nominal location based on the obtained data and the at least one input. The method comprising determining at least one second nominal location based on processing the first nominal location, the obtained data and the at least one input.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and a method for selecting and deploying an optimal site from a list of candidate sites.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

5G networks are biggest enabler for industry 4.0 and provides high bandwidth, ultra-low latency and massive Internet of Things (IoT) deployments.

For providing these types of deployments, there is a need for effective and efficient 5G network planning and deployment. Worldwide there are approximately 4 million cell sites radiating 4G networks, which were deployed while focusing on providing only mobile broadband service. Fifth generation cellular network promises ranges of services broadly categorized into enhanced mobile broadband (eMBB), Ultra-reliable and Low-Latency communication (uRLLC) and Massive Machine Type Communications (mMTC). As every service type has different design targets so planning and deployment needs to be tailored for a target service.

Using a conventional approach to connect millions of devices with wide ranges of possible 5G uses cases and humans using higher frequency bands, it is a very cumbersome and complex process to run multiple iterations and plan to get an optimal site plan and cell configuration designed for a given coverage and capacity criteria. This is because the task of network planning is done conventionally by hundreds of engineers using desktop based tools, which involve huge man-hours for collecting the data, pre-processing followed by radio predictive tasks to determine best possible locations for new proposed sites and cell level physical problems. Therefore, the traditional approach is manual and tedious as well. Few of the challenges faced while using the conventional approach for network planning are involvement of manual and tedious work, undefined planning processes, challenges in dealing with crowd-sourced data, inability of scale, requirement of a steep learning curve, challenges faced in storing and doing spatial queries on geo datasets such as fiber, hotspots, etc.

There is, therefore, a need in the art for an improved system and method that effectively provides a strategy to determine an optimum site from determined multiple identified sites.

### SUMMARY

In an exemplary embodiment, the present invention discloses a method for determining and deploying a nominal site location for cellular planning in a wireless network. The method comprising receiving, from one or more data sources, geographic data related to a geographic region of interest. The method comprising obtaining a data for the geographic region of interest. The data, in one example, refers to clutter type data and infrastructure type data. The infrastructure type data includes data from nearby fiber route point, fiber structure, equipment and on-air sites present in the geographic region of interest. The method comprising receiving at least one input for the cellular planning. The at least one input comprising custom inputs. The method comprising identifying a first nominal location based on the obtained data and the at least one input. The method comprising determining at least one second nominal location based on processing the first nominal location, the obtained data and the at least one input. In some embodiments, the obtained data comprises a clutter type data, and infrastructure type data.

The method may include generating one or more nominal locations concurrently or serially or both. In one example, the data sources may include building and demand point data sources. The method may include obtaining further inputs from user including exclusion zones, and other inputs.

In some embodiments, the method further comprising determining a distance between the first nominal location and the at least one second nominal location.

In some embodiments, the method further comprising selecting the first nominal location and the at least one second nominal location when the determined distance is more than a product of a coefficient and a cell radius. The determined distance and the cell radius both are custom inputs as part of algorithm settings. The cell radius is theoretical distance where cell/site can provide coverage.

In some embodiments, the method further comprising determining at least one priority nominal site based on the obtained data when the determined distance is less than a product of the coefficient and the cell radius.

In some embodiments, the determined priority nominal site is based on a priority provided to each data source by the user.

In some embodiments, the coefficient and the cell radius are custom input defined by the user.

In some embodiments, the method further comprising selecting at least one indoor small cell and at least one outdoor small cell after selecting the first nominal location and the at least one second nominal location.

In some embodiments, the method further comprising performing a network planning and deployment based on the first nominal location and the at least one second nominal location.

In an exemplary embodiment, the present invention discloses a system for determining and deploying a nominal site location for cellular planning in a wireless network.

The system comprising a receiving unit configured to receive at least one input for the cellular planning, a database configured to store a geographic data related to a geographic region of interest, and an input data. The geographic data is received from one or more data sources. A processing unit coupled to the receiving unit and the database and is configured to identify a first nominal location based on the data and the at least one input and determine at least one second nominal location based on processing the first nominal location, the obtained data and the at least one input.

In some embodiments, the obtained data comprises a clutter type data, and infrastructure type data.

In some embodiments, the system is further configured to determine a distance between the first nominal location and the at least one second nominal location.

In some embodiments, the system is further configured to select the first nominal location and the at least one second nominal location when the determined distance is more than a product of a coefficient and a cell radius.

In some embodiments, the system further configured to determine at least one priority nominal site based on the obtained data when the determined distance is less than a product of the coefficient and the cell radius.

In some embodiments, wherein the determined at least one priority nominal site is based on a priority provided to each data source by the user.

In some embodiments, the coefficient and the cell radius are custom input defined by the user.

In some embodiments, the system is further configured to select at least one indoor small cell and at least one outdoor small cell after selecting the first nominal location and the at least one second nominal location.

In some embodiments, the system is further configured to perform a network planning and deployment based on the first nominal location and the at least one second nominal location.

In an exemplary embodiment, the present invention discloses a wireless network comprising a system for determining and deploying a nominal site location for cellular planning in a wireless network. The system comprising a receiving unit configured to receive at least one input for the cellular planning, a database configured to store a geographic data related to a geographic region of interest, and an input data. The geographic data is received from one or more data sources. A processing unit coupled to the receiving unit and the database and is configured to identify a first nominal location based on the data and the at least one input and determine at least one second nominal location based on processing the first nominal location, the obtained data and the at least one input.

The foregoing general description of the illustrative embodiments and the following detailed description thereof are merely exemplary aspects of the teachings of this disclosure and are not restrictive.

### OBJECTS OF THE PRESENT DISCLOSURE

It is an object of the present disclosure to provide a system and a method to select and deploy an optimal site from a list of candidate sites.

It is an object of the present disclosure to process the site selection and deployment by using a simple web interface where input requirements for a geography are defined.

It is an object of the present disclosure to provide an automated mechanism for ingesting huge crowdsource data, geospatial data, making predictions and performing analysis for determining the optimal site.

It is an object of the present invention to improvise the network system of an area.

It is an object of the present invention to enhance the user experience.

It is an object of the present invention to expedite the network deployments.

It is an object of the present invention to optimize the cost involved in planning and deployment of the network sites.

It is an object of the present invention to optimize the network deployment and cover the maximum area using a cell site.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIGS. 1A-1B illustrate a site selection mechanism for determining and selecting an optimum site from multiple candidate sites, in accordance with an embodiment of the present disclosure.

FIG. 2 illustrates an indoor small cell selection mechanism, in accordance with an embodiment of the present disclosure.

FIG. 3 illustrates an outdoor small cell selection mechanism, in accordance with an embodiment of the present disclosure.

FIG. 4 illustrates an exemplary computer system in which or with which embodiments of the present disclosure may be implemented.

### LIST OF REFERENCE NUMERALS

100A—Flow diagram
100B—Flow diagram
200—Flow diagram
300—Flow diagram
400—A computer system
410—External storage device
420—Bus
430—Main memory
440—Read only memory
450—Mass storage device
460—Communication port(s)
470—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Available End to End (E2E) automated system and methodology for 5G planning addresses site selection problem by providing unique sets of web applications for automated 5G planning and deployment. The disclosed system and method are based on a cloud native architecture, which eliminates available traditional desktop-based approach with new innovative and automated planning using radio Application Programming Interfaces (APIs) hosted on a centralized infrastructure. This guarantee providing an optimal planning output and network insights in a time bound manner for making quick business decisions. The disclosed system and method focus on selection of an optimum site from a set of identified sites.

For site selections there is a need to maintain logs of execution of each data source along with their execution status. This may be used for landing page status as well as for defining chaining of jobs. A sequence of execution steps for all data sources may be, for example (a) rollout obligations, (b) exclusion zone, (c) site selection, (d) site list preparations, and (e) input to nominal validations. These execution steps cannot be executed in parallel.

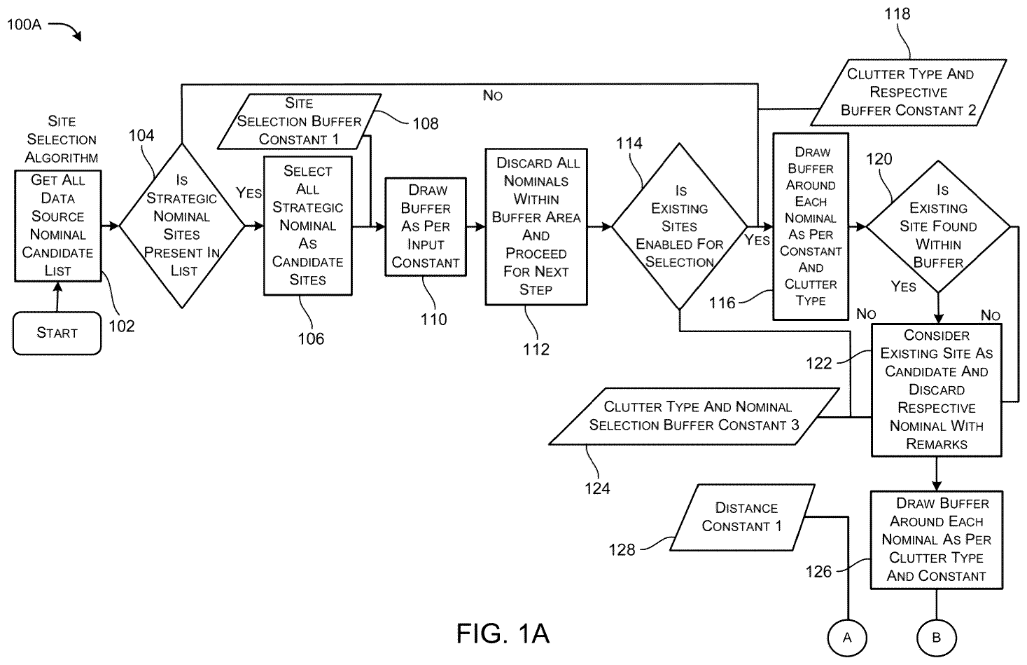

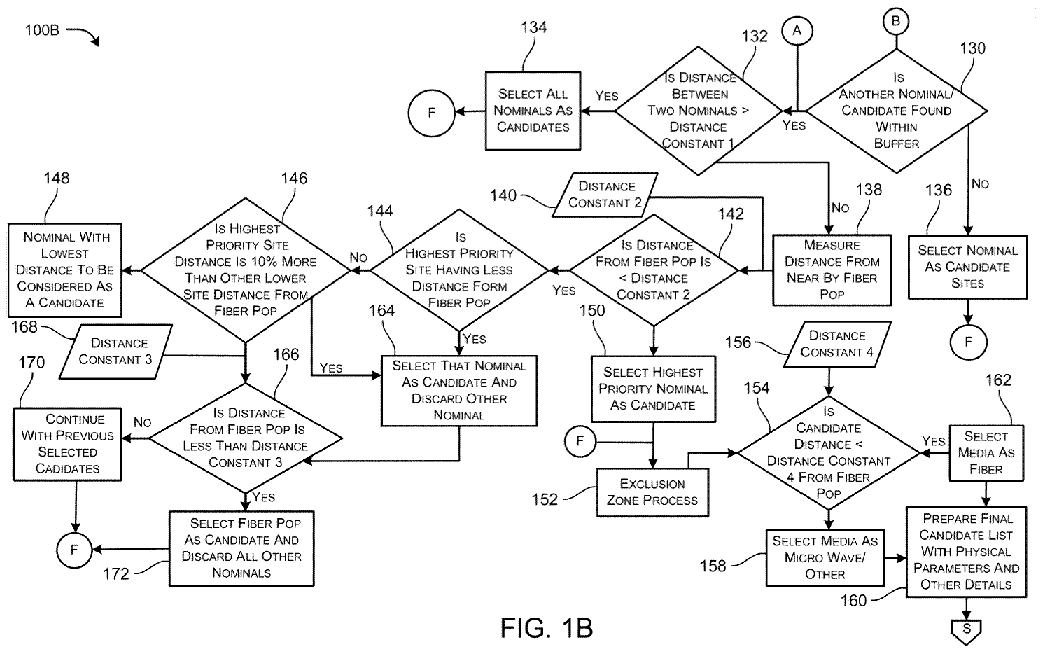

In an embodiment is disclosed a macro site selection process. FIGS. 1A-1B illustrate a site selection mechanism 100A and 100B for determining and selecting an optimum site from multiple candidate sites, in accordance with an embodiment of the present disclosure. At step 102, get all data source nominal candidate list. At step 104, checking is strategic nominal sites present in list. The nominal site is location where site is proposed based on respective data source site generation criteria. At step 106, select all strategic nominal as candidate site when strategic nominal sites present in list. At step 108, site select site selection buffer constant. At step 110, draw buffer as per input constant. At step 112 discard nominals within buffer area. At step 114, checking if existing sites enabled for selection. At step 118, enter clutter type and respective buffer constant to draw buffer around each nominal as per constant and clutter type (at step 116) when existing sites enabled for selection. At step 120, it is checked if existing site found within buffer. At step 122, consider existing site as candidate and discard respective nominal with remarks. At step 124, input clutter type and nominal selection buffer constant. At step 126, draw buffer around each nominal as per clutter type and constant. At step 128, enter distance constant 2. At step 130, checking is another nominal candidate found within buffer. At step 132, when step 130 is affirmative, checking if distance between two nominals is greater than distance constant 2. At step 134, select all nominal as candidates when distance between two nominals is greater than the distance constant 2. At step 136, when step 130 is not affirmative, select nominal as candidate site. At step 138, measure distance from nearby fiber point when the distance between two nominals is less than the distance constant. At step 140, enter distance constant. At step 142, checking if distance from fiber point is less than the distance constant 2 and if yes, checking is highest priority site having less distance from fiber point (at step 144) and if yes, select that nominal as candidate and discard other nominals (at step 164). At step 146, when it is checked that the highest priority site having more distance from fiber point, then check if high priority site distance from structure/equipment is 10% more than distance from lower priority site then select high priority nominal. At step 148, nominal with lowest distance to be considered as a candidate. At step 168, enter distance constant 3 and calculate if distance from fiber point is less than the distance constant 3 (at step 166) and if yes, select fiber point as candidate and discard all other nominals (at step 172). At step 170, continue with previous selected candidates when distance from fiber point is not less than the distance constant 3. At step 154 calculate is candidate distance is less than distance constant 4 entered at step 156. At step 158, select media as micro wave/other. At step 162, select media as fiber and at step 160 prepare final candidate list with physical parameter and other details. At step 150, select highest priority nominal as candidate and at step 152 run exclusion zone process and input it at step 154.

In an aspect, the steps for the selection process may include (1) considering all strategic site as final nominal, and drawing a buffer of X meter (strategic site buffer), (2) identifying all nominals within strategic buffer and discarding all candidate with remarks as “within x meter distance from strategic site” and following below steps for remaining candidates, (3) identifying underlying clutter type for each nominal candidate, (4) drawing buffer of ‘A’ meters (buffer for existing site) from each of nominals, (5) if any existing on-air/planned site is found within buffer, consider existing on-air/planned site as a nominal, else consider process at step (7). (This is to be considered as per inputs, however, if a user select does not consider on-air sites in nominal planning then this step may be excluded from site selections), (6) get on-air site/planned details such as SAP ID, location, azimuth, height, media information's and update remarks as “on-air sites within ‘X’ meter for nominal” which is discarded, (7) draw buffer around each nominal with radius of X meters cell radius, (8) check for any other nominal with each buffer, (9) if any other nominal is present use plan B else use plan A,
(10) Plan A: (a) measure distance from nearby fiber route point, fiber structure, equipment and on-air 4G sites
   (b) Get fiber route type, structure/equipment name, 4G sites SAP ID and distance from each for report
(11) Plan B: (a) measure distance between each nominal within buffer
   (b) If distance between nominal is more than 0.8 X Cell radius, select both nominals
   (c) If distance is less than 0.8 X cell radius follow below steps:
   (d) Measure distance from nearby structure/equipment
   (e) If distance from nearby structure/equipment is less than 1000 meter, then follow path A else follow path B
   (f) Path A:
   (g) Check for priority of nominal sites
      (i) If high priority among all candidates having lowest distance from structure/equipment, select that nominal as a final one and ignore other nominals
      (ii) If high priority sites have more distance from structure/equipment then check high priority nominal distance from fiber route nearby points. In case, distance from high priority nominal from fiber route is less than distance of low priority site from structure/equipment then selects high priority candidate else follow the below step.
      (iii) If high priority site distance from structure/equipment is 10% more than distance from lower priority site then select high priority nominal else follow below step
      (iv) Put remarks for all discarded nominal as “high priority candidate selected”
      (v) Select low priority nominal which has lowest distance from structure/equipment (update remarks as “low priority candidate on fiber location” for all discarded nominals)
      (vi) If selected nominal distance is within 20 meters (fiberized distance) then consider structure/equipment location as a candidate and update remarks as “structure/equipment available within X meters as not selection remarks for excluding nominals.
   (h) Path B:
      (i) Check for priority of each nominal sites and select sites with highest priority (remarks for discarding candidates—Other high priority nominal considered”)
   (i) Measure distance from nearby fiber route point, fiber structure, equipment and on-air 4G sites,
   (j) Get fiber route type, structure/equipment name, 4G sites SAP ID and distance from each for report
(12) No sites to be planned in exclusion zone area, and if any nominal falls within the exclusion zone, then mark “exclusion zone” as remarks for such nominals.
(13) All discarded sites are marked with reasons for not considering in final plan.

In an embodiment, is disclosed an indoor small cell selection process that is to be triggered post completion of macro site selection.

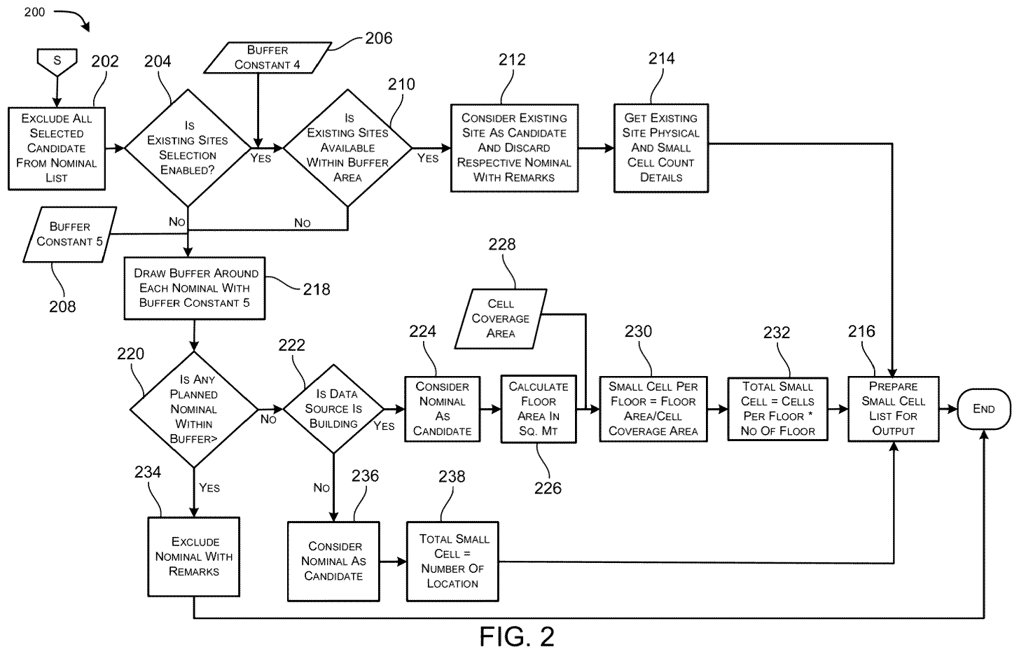

FIG. 2 illustrates an indoor small cell selection mechanism 200, in accordance with an embodiment of the present disclosure.

At step 202, exclude all selected candidate from nominal list.

At step 204, check if existing sites selection enabled and if yes, then at step 210, check if existing sites are available within buffer area by entering buffer constant 2 at 206.

Then at 212, consider existing site as candidate and discard respective nominal with remarks and at 214, get existing site physical and small cell count details. At 216, prepare small cell list for output.

At step 208, enter buffer constant 5 and at 218, draw buffer around each nominal with buffer constant 5 when step 204 and step 210 are not affirmative.

At step 220, check if any planned nominal is within buffer and if yes then at 234 exclude nominal with remarks at 234 and if no, then the at 222, check if data source is a building.

At step 236 consider nominal as candidate when step 222 is not affirmative and at 238 calculate total small cell-number of locations.

At step 224, consider nominal as candidate when step 222 is affirmative.

At step 226, calculate floor area in sq. mt.

At step 228, enter cell coverage area and at step 230 calculate small cell per floor=floor area/cell coverage area.

At step 232, calculate total small cell=cells per floor*number of floors

As illustrated, the selection process includes:
1. Considering all strategic site with indoor small cells as a site type with number of small cells
2. If any existing indoor on-air/planned site is found with building ID same as valid nominal building ID, then considering existing on-air/planned site as a nominal else process to the next step (This step is to be considered as per user inputs. If the user does not select consider on-air sites/planned in nominal planning then this step is excluded from site selections)
3. Getting on-air/planned site details such as SAP ID, location, azimuth, height, media, number of cells information's
4. Processing for building and demand point data sources
   i) User building data source for indoor small cell planning
   ii) Building nominal which is valid and not considered in macro site to be considered for indoor small cell planning planning
   iii) Calculate distance of all valid nominal from nearby macro nominal candidates
   iv) If distance of valid building nominals is more than X meters (small cell distance) then consider such building for indoor small cell nominals
   v) Calculate area of building polygon in Sq. Meter
   vi) Number of indoor small cell per floor=roundup (building polygon area/small cell coverage area, 0)
   vii) Total number of indoor small cell=number of indoor small cell X number of floor in building
5. Processing for other data sources
   i) Nominal which is valid and not considered in macro site planning to be considered for indoor small cell planning
   ii) Calculate distance of all valid nominal from nearby macro candidates nominal
   iii) If distance of valid nominals is more than X meters (small cell distance) then consider such nominal for indoor small cell nominals.
   iv) Number of indoor small cells=1 small cell per locations

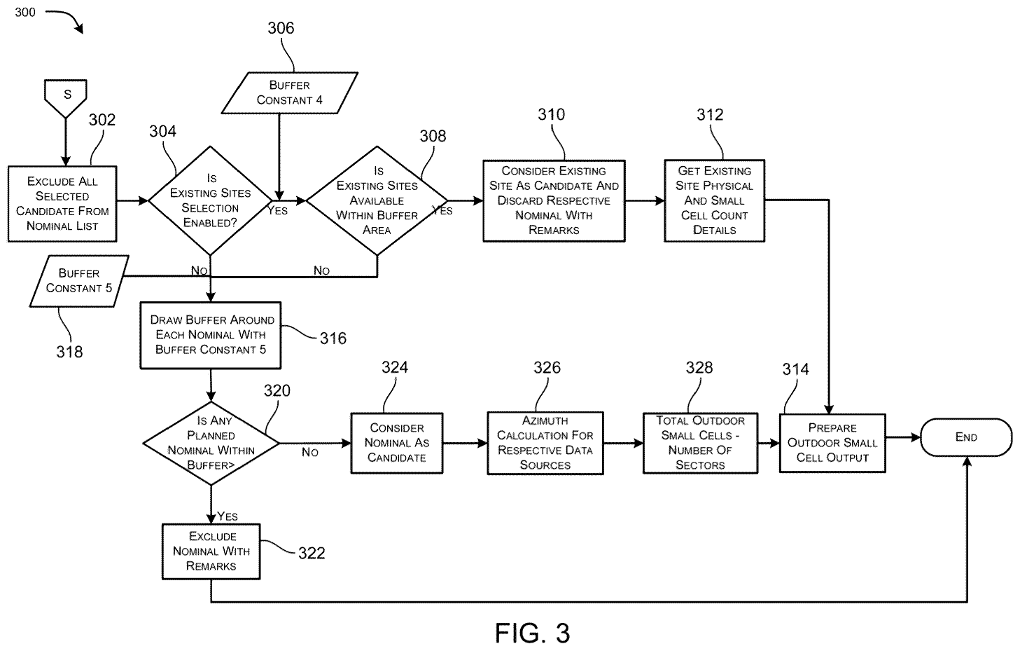

In an embodiment, is disclosed an outdoor small cell selection process that is to be triggered post completion of the macro site selection. FIG. 3 illustrates an outdoor small cell selection mechanism 300, in accordance with an embodiment of the present disclosure.

At step 302, exclude all selected candidate from nominal list. At step 304, check if existing sites selection enabled and if yes, then at step

308 check if existing sites are available within buffer area by entering buffer constant 4 at 306.

Then at 310, consider existing site as candidate and discard respective nominal with remarks and at 312, get existing site physical and small cell count details.

At 314, prepare outdoor small cell output.

At step 318, enter buffer constant 5 and at 316, draw buffer around each nominal with buffer constant 5 when step 304 and step 308 are not affirmative.

At step 320 check is any planned nominal is within buffer if yes then at 322 exclude nominal with remarks and if no, consider nominal as candidate at 324.

At step 326 perform azimuth calculation for respective data sources and at 328 calculate total outdoor small cell-number of sectors.

As illustrated, the selection process includes:
(a) Considering all strategic site with outdoor small cells as a site type with number of small cells
(b) Nominal which is valid and not considered in macro site planning to be considered for outdoor small cell planning
(c) Calculating distance of all valid nominal from nearby macro and outdoor small cell nominal candidates
(d) If distance of valid nominals is more than X meters (outdoor small cell distance) then consider such nominal for outdoor small cell nominals
(e) Number of indoor small cells=number of sectors identified for data source nominals respective
(f) If any existing outdoor on-air/planned site is found within X meter buffer (existing outdoor buffer), then consider existing on-air/planned site as a nominal (this to be considered as per inputs, if the user selection does not consider on-air/planned sites in nominal planning, then this step is excluded from site selections)
(g) Get on-air site/planned details such as SAP ID, location, azimuth, height, media and number of outdoor cells, and information about number of sectors.

Therefore, the disclosed system and method facilitates to automate the process of site selection and deployment by providing a simple web interface. This is done by the user defining an input requirement for a geography. Thus, the entire process of ingesting huge crowdsource data, geospatial data, making predictions, and performing analysis for obtaining the optimal sites from a set of candidate sites is fully automated.

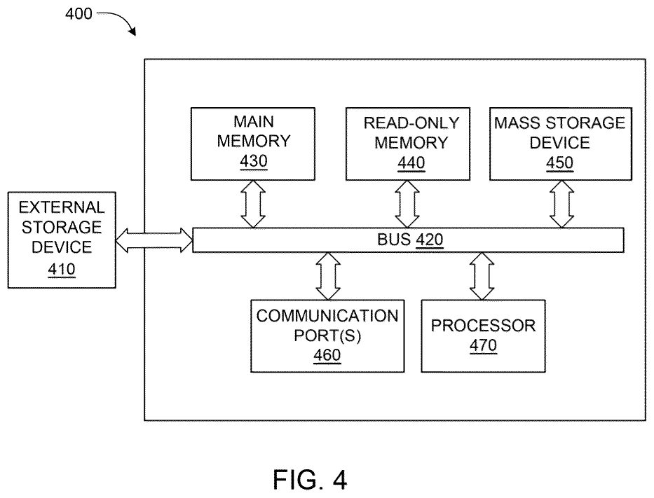

FIG. 4 illustrates an exemplary computer system 400 in which or with which embodiments of the present disclosure may be implemented. As shown in FIG. 4, the computer system 400 may include an external storage device 410, a bus 420, a main memory 430, a read-only memory 440, a mass storage device 450, communication port(s) 460, and a processor 470. A person skilled in the art will appreciate that the computer system 400 may include more than one processor and communication ports. The processor 470 may include various modules associated with embodiments of the present disclosure. The communication port(s) 460 may be any of an RS-232 port for use with a modem based dialup connection, a 10/100 Ethernet port, a Gigabit or 10 Gigabit port using copper or fiber, a serial port, a parallel port, or other existing or future ports. The communication port(s) 460 may be chosen depending on a network, such a Local Area Network (LAN), Wide Area Network (WAN), or any network to which the computer system 400 connects. The main memory 430 may be random access memory (RAM), or any other dynamic storage device commonly known in the art. The read-only memory 440 may be any static storage device(s) e.g., but not limited to, a Programmable Read Only Memory (PROM) chips for storing static information e.g., start-up or BIOS instructions for the processor 470. The mass storage device 450 may be any current or future mass storage solution, which can be used to store information and/or instructions. Exemplary mass storage device 450 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 420 communicatively couples the processor 470 with the other memory, storage, and communication blocks. The bus 420 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 470 to the computer system 400.

Optionally, operator and administrative interfaces, e.g., a display, keyboard, joystick, and a cursor control device, may also be coupled to the bus 420 to support direct operator interaction with the computer system 400. Other operator and administrative interfaces can be provided through network connections connected through the communication port(s) 460. Components described above are meant only to exemplify various possibilities. In no way should the aforementioned exemplary computer system 400 limit the scope of the present disclosure.

In an exemplary embodiment, the present invention discloses a method for determining and deploying a nominal site location for cellular planning in a wireless network. The method comprising receiving, from one or more data sources, geographic data related to a geographic region of interest. The method comprising obtaining a data for the geographic region of interest. The data, in one example, refers to clutter type data and infrastructure type data. The infrastructure type data includes data from nearby fiber route point, fiber structure, equipment and on-air sites present in the geographic region of interest. The method comprising receiving at least one input for the cellular planning. The at least one input comprising custom inputs. The method comprising identifying a first nominal location based on the obtained data and the at least one input. The method comprising determining at least one second nominal location based on processing the first nominal location, the obtained data and the at least one input. In some embodiments, the obtained data comprises a clutter type data, and infrastructure type data.

The method may include generating one or more nominal locations concurrently or serially or both. In one example, the data sources may include building and demand point data sources. The method may include obtaining further inputs from user including exclusion zones, and other inputs.

In some embodiments, the method further comprising determining a distance between the first nominal location and the at least one second nominal location.

In some embodiments, the method further comprising selecting the first nominal location and the at least one second nominal location when the determined distance is more than a product of a coefficient and a cell radius. The determined distance and the cell radius both are custom inputs as part of algorithm settings. The cell radius is theoretical distance where cell/site can provide coverage.

In some embodiments, the method further comprising determining at least one priority nominal site based on the obtained data when the determined distance is less than a product of the coefficient and the cell radius.

In some embodiments, the determined priority nominal site is based on a priority provided to each data source by the user.

In some embodiments, the coefficient and the cell radius are custom input defined by the user.

In some embodiments, the method further comprising selecting at least one indoor small cell and at least one outdoor small cell after selecting the first nominal location and the at least one second nominal location.

In some embodiments, the method further comprising performing a network planning and deployment based on the first nominal location and the at least one second nominal location.

In an aspect, the present invention can be implemented in a system comprising a receiving unit, a database and a processing unit for the cellular planning. The system may comprise a tool that comprises a web interface where a plurality of inputs can be entered for the determining nominal locations.

Thus, the present invention streamlines the cellular planning process by automating & stitching all the components and providing an optimal site/cell list.

The present disclosure automates the process of site selection and deployment by providing a simple web interface on a platform. The user can define the input requirement for any geography. Thus, the entire process of ingesting huge crowdsource data, geospatial data & doing predictions & analysis for getting the optimal sites has been fully automated. The present disclosure is configured to be employed in a communication system that requires planning & design of 5g network.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure facilitates to select and deploy an optimal site from a list of candidate sites.

The present disclosure processes the site selection and deployment by using a simple web interface where input requirements for a geography are defined.

The present disclosure provides an automated mechanism for ingesting huge crowdsource data, geospatial data, making predictions and performing analysis for determining the optimal site.

The present disclosure improvises the network system of an area.

The present disclosure enhances the user experience.

The present disclosure expedites the network deployments.

The present disclosure facilitates to optimize the cost involved in planning and deployment of the network sites.

The present disclosure facilitates to optimize the network deployment and cover the maximum area using a cell site.

We claim:

1. A method for determining and deploying a nominal site location for cellular planning in a wireless network, the method comprising:
receiving, from one or more data sources, geographic data related to a geographic region of interest;
obtaining a data for the geographic region of interest;
receiving at least one input for the cellular planning;
identifying a first nominal location based on the obtained data and the at least one input; and
determining at least one second nominal location based on processing the first nominal location, the obtained data and the at least one input.

2. The method as claimed in claim 1, wherein the obtained data comprises a clutter type data, and infrastructure type data.

3. The method as claimed in claim 1, further comprising determining a distance between the first nominal location and the at least one second nominal location.

204. The method as claimed in claim 1, further comprising selecting the first nominal location and the at least one second nominal location when the determined distance is more than a product of a coefficient and a cell radius.

5. The method as claimed in claim 1, further comprising determining at least one priority nominal site based on the obtained data when the determined distance is less than a product of the coefficient and the cell radius.

6. The method as claimed in claim 1, wherein the determined priority nominal site is based on a priority provided to each data source by a user.

7. The method as claimed in claim 1, wherein the coefficient and the cell radius are custom input defined by the user.

8. The method as claimed in claim 1, further comprising selecting at least one indoor small cell and at least one outdoor small cell after selecting the first nominal location and the at least one second nominal location.

9. The method as claimed in claim 1, further comprising performing a network planning and deployment based on the first nominal location and the at least one second nominal location.

10. A system for determining and deploying a nominal site location for cellular planning in a wireless network, the system comprising:
a receiving unit configured to receive at least one input for the cellular planning;
a database configured to store a data related to a geographic region of interest, and an input data; wherein the geographic data is received from one or more data sources;
a processing unit coupled to the receiving unit and the database and is configured to:
identify a first nominal location based on the data and the at least one input; and
determine at least one second nominal location based on processing the first nominal location, the obtained data and the at least one input.

11. The system as claimed in claim 10, wherein the obtained data comprises a clutter type data, and infrastructure type data.

12. The system as claimed in claim 10, further configured to determine a distance between the first nominal location and the at least one second nominal location.

13. The system as claimed in claim 10, further configured to select the first nominal location and the at least one second nominal location when the determined distance is more than a product of a coefficient and a cell radius.

514. The system as claimed in claim 10, further configured to determine at least one priority nominal site based on the obtained data when the determined distance is less than a product of the coefficient and the cell radius.

15. The system as claimed in claim 10, wherein the determined at least one priority nominal site is based on a priority provided to each data source by a user.

16. The system as claimed in claim 10, wherein the coefficient and the cell radius are custom input defined by the user. 1517. The system as claimed in claim 10, further configured to select at least one indoor small cell and at least one outdoor small cell after selecting the first nominal location and the at least one second nominal location.

18. The system as claimed in claim 10, further configured to perform a network planning and deployment based on the first nominal location and the at least one second nominal location.

19. A wireless network comprising a system for determining and deploying a nominal site location for cellular planning in a wireless network, the system comprising:
a receiving unit configured to receive at least one input for the cellular planning;
a database configured to store a data related to a geographic region of interest, and an input data; wherein the geographic data is received from one or more data sources;
a processing unit coupled to the receiving unit and the database and is configured to:
identify a first nominal location based on the data and the at least one input; and
determine at least one second nominal location based on processing the first nominal location, the obtained data and the at least one input.

20. A computer program product comprising a non-transitory computer-readable medium comprising instructions that, when executed by one or more processors, cause the one or more processors to perform a method for determining and deploying a nominal site location for cellular planning in a wireless network, the method comprising:
receiving, from one or more data sources, geographic data related to a geographic region of interest;
obtaining a data for the geographic region of interest;
receiving at least one input for the cellular planning;
identifying a first nominal location based on the obtained data and the at least one input; and
determining at least one second nominal location based on processing the first nominal location, the obtained data and the at least one input.
